(19) United States
(12) Patent Application Publication
(10) Pub. No.: US 2015/0242889 A1
(43) Pub. Date: Aug. 27, 2015

(54) SYSTEMS AND METHODS FOR EVENT PURCHASE AND UPGRADE OPTIONS BASED ON USER PARAMETERS

(71) Applicants: Kamal Zamer, Austin, TX (US); Matthew Scott Zises, San Jose, CA (US)

(72) Inventors: Kamal Zamer, Austin, TX (US); Matthew Scott Zises, San Jose, CA (US)

(21) Appl. No.: 14/190,925

(22) Filed: Feb. 26, 2014

(51) Int. Cl. G06Q 30/02

(52) U.S. Cl. CPC G06Q 30/0252

(57) ABSTRACT

There is provided systems and method for event purchase and upgrade options based on user parameters. A user may attend an event at a venue and have purchased admission for the event. Prior to attending the event, the user's actions throughout the day may be tracked, such as an amount of sleep the user had the previous night and/or a workload throughout a day. Additionally, information about the venue may be collected, such as weather parameters and available ticketing. Based on the parameters of the user and/or the expected parameters of the user at the venue, the user may be offered upgrades to the user's admission. Thus, the user may be able to sit in VIP seating if the user is tired or find a covered seating during warm weather. Moreover, items from merchants at the venue may be offered to the user based on the user's parameters.

### TECHNICAL FIELD

The present application generally relates to event purchase and upgrade options based on user parameters and more specifically to offering upgrades to event admission tickets and purchases from merchants at a venue based on a user's current or expected physical, financial, or other parameter.

### BACKGROUND

Users may purchase tickets for events at venues, including sporting events, concerts, and the like. Often, due to ticket demands, users may purchase tickets several weeks to months ahead of an event. Thus, as the date closes to the actual event, several external factors may affect the user's experience at the event. For example, the user might not expect a particular part of the year to come with a heat wave that causes a partially covered event to be unexpectedly warm in the sun. Other times, the user's current work load may cause the user to be too tired to stand in a general admission area. Thus, users may end up wasting tickets or not enjoying an event because they were not able to change their plans as the event drew closer.

Users may bring user devices, such as mobile phones, smart watches and glasses, and tablet computers, with them when they travel, including to an event. The user devices enable the user to provide electronic proof of admission to the event. Additionally, user devices provide other information to the user, such as crowd size at the event, information about the event (e.g., start/delay times, merchants at the event, etc.), and weather conditions. However, while a user may be able to collect information to help them make informed choices about the event and venue, if the user has previously purchased admission for the event at the venue, the user is locked in to attending using that admission.

### BRIEF DESCRIPTION OF THE DRAWINGS

FIG. 1 is a block diagram of a networked system suitable for implementing the process described herein, according to an embodiment;

FIG. 2 is an exemplary interaction between a ticketing server and a user device for providing purchase and upgrade options for a venue, according to an embodiment;

FIG. 3 is an exemplary system environment displaying a user at an event and receiving purchase and upgrade options based on the parameters of the user, according to an embodiment;

FIG. 4 is a flowchart of an exemplary process by a server for purchase and upgrade options based on user parameters, according to an embodiment; and

FIG. 5 is a block diagram of a computer system suitable for implementing one or more components in FIG. 1, according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may purchase admission to an event at a venue, such as tickets to sporting events, concerts, shows, etc. The admission may include a type of admission for the price (e.g., general admission, reserved seats, VIP seating, etc.) as well as a date and time for the event, or a selection of dates and times for a plurality of events (including the option to choose a specific date and time). A user device and/or server may store the user's admission information for future reference when the user plans on attending the event,

Additionally, information pertaining to a state or parameter of the user may be gathered and stored by the server. The information may be collected over a period of time so that a likely parameter of the user may be determined, or may be gathered based on the user's current disposition (e.g., cold, sweaty, etc.). For example, in certain embodiments, a user's sleep pattern may be estimated based on usage of a user device, including when the user stops using a user device at night and/or when a user device alarm is set or the user resumes using the user device. Based on the amount of time the user is determined to be sleeping, the server may estimate if the user is likely to be tired. Information on sleep patterns may be collected over a period of time, so that users who frequently sleep 8-9 hours a night and users who sleep 5-6 hours a night both have a baseline established of an adequate sleep amount. Additionally, user daily activity may be similarly considered when determining a parameter of the user. If the user has had meetings, travel, and/or exercise based on the user's location, calendar, and/or email/messaging, the user may be determined to be tired. If the user often exercises, but foregoes exercising on days the user has more than a certain amount of meetings, the user may also be determined to be tired. However, if the user has had the day off, such as being located in a home location, refraining from emailing, or at a “vacation” area, the user might be considered to be refreshed.

Information pertaining to the state of the user may also be gathered as the user approaches or is located at the venue. For example, a thermometer or weather application on the phone may determine if the user is hot or cold. Other devices, such as smart glasses and/or watches may be able to take a user's core temperature, skin temperature/moisture, or an ambient temperature/moisture. In other embodiments, information about the parameters at the venue may be crowd sourced from other users at the venue or may be scraped from one or more social networking feeds, microblogging services, or similar resources. Parameters of the user at the venue or prior to the venue may be determined through previous and/or current user purchases, such as caffeinated drinks, hot/cold beverages, food items, etc. Moreover, a parameter of the user may correspond to a current financial situation, thus indicating whether the user might instead prefer more expensive purchases that they can afford. Thus, parameters may be determined using user purchases, user physical activity, user work activity, a user financial account, weather parameters for the venue, temperature levels at a location of the user within the venue, etc.

Once user admission information and parameters are determined and accessed, purchase options for the user at the venue may be determined using the admission information and the parameters of the user. Purchase options may correspond to different seating for the admission information. For example, a tired user may prefer seated admission instead of general standing admission. A user who has been paid recently or has a large financial account may prefer to upgrade to VIP passes. Users attending warm venues may prefer to purchase covered seating or tickets available in cooler sections of the venue may be provided to the user so the user may move to another section. In other embodiments, a user who is profusely sweating or ordering excess bottles of water while at a warm venue may be instructed of cooler sections of the venue or offered an option to switch to seats in air conditioned sections.

In other embodiments, the purchase options may correspond to items available from merchants at the venue. For example, if a user is tired, or has missed dinner due to a meeting prior to attending the venue, then the user may be instructed of places to pick up coffee or food. Additionally, if the venue is warm, the user may have an option to purchase water ahead of time and/or at a discounted rate that is available for pick up once the user reaches the venue/merchant. While at the venue, the user may purchase water through a mobile device transaction, or may purchase water and instruct the merchant to locate the user at the venue for delivery using location services of the mobile device with the user. Thus, the user may engage in transactions prior to and while at the venue that are offered to the user based on the user's parameters.

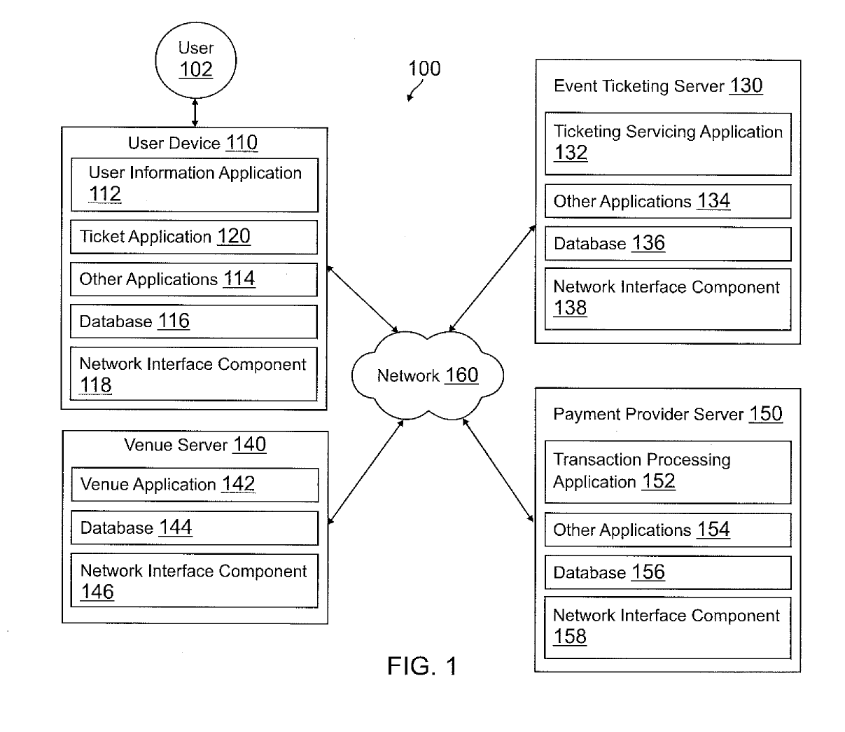

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, an event ticketing server 130, a venue server 140, a payment provider server 150 in communication over a network 160. User 102, such as a consumer, utilizes user device 110 to purchase admission to an event at a venue corresponding to venue server 140. These actions may be facilitated by event ticketing server 130, venue server 140, and/or payment provider server 150 in certain embodiments. As the event approaches, information corresponding to parameters of user 102 may be gathered by event ticketing server 130 through user device 110, venue server 140, and/or payment provider server 150. Thus, purchase options may be offered to user 102 through user device 110 based on user 102's admission information and parameters. Purchase options may be determined using information from user device 110, event ticketing server 130, venue server 140, and/or payment provider server 150.

User device 110, event ticketing server 130, venue server 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a user information application 112, a ticket application 120, other applications 114, a database 116, and a network interface component 118. User information application 112, ticket application 120, and other applications 114 may correspond to processes, procedures, and/or applications executable by a hardware processor, for example, a software program. In other embodiments, user device 110 may include additional or different software as required.

User information application 112 may include processes and/or procedures to collect information corresponding to at least one parameter of user 102. In various embodiments, user information application 112 may correspond to a single application collecting information corresponding to one or a plurality of parameters. However, in other embodiments, user information application 112 may correspond to a plurality of applications collecting a plurality of different types of information related to one or a plurality of parameters of user 102. In various embodiments, user information application 112 may correspond generally to a browser, email, text message, or other application enabling network communications for user device 110 and capable of accessing communications and schedules of user 102, including email, chat, scheduling, and similar account. However, user information application 112 may also correspond to offline calendaring, clock (including alarm and sleep features), weather, mapping, health (e.g., heart rate, core temperature, nutrition, etc.), or other application capable of collection information about parameters of user 102.

Thus, user information application 112 may receive, transmit, and otherwise collect information corresponding to parameters of user 102. Parameters of user 102 may correspond to a sleep level of user 102 determined from a previous night's rest and/or pattern of sleep behaviors of user 102. For example, an amount of sleep may be estimated based on a last time of usage of user device 110 by user 102 with a first time of usage the following morning and/or an alarm setting of a clock application. Over a period of time, an average nightly amount of sleep may be estimated of user 102. Thus, if on a night before a scheduled event that user 102 has admission tickets for, user 102 sleeps less, the same, or more than the average nightly amount of sleep, a rest level of user 102 may be estimated.

Additionally, a rest level of user 102 may be estimated based on information available with a calendaring, schedule, mapping, and/or nutrition application corresponding to user information application 112. In various embodiments, a calendaring application may map multiple meetings, errands, or other work events that may cause user 102 to be tired. If user 102 has a larger than normal work load, deviates from a standard schedule (e.g., skips a run or the gym), user 102 may be considered to be tired. The effects of schedule changes may be cumulative, so that a high amount of meetings together with a deviation to remove a normal daily activity may suggest a certain parameter of user 102. In certain embodiments, mapping and/or nutrition applications may further be utilized to determine if user 102 has travelled a large amount that day, has exercised more or less that day, or has other parameters that may affect a parameter of user 102.

Information about parameters collected by user information application 112 may also relate to actions the user may wish to take or avoid prior to or while attending the venue the user has admission for. Thus, user information application 112 may collect information about eating habits of user 102 for use with determining whether user 102 will be hungry and enjoy certain available foods at or near the venue. Additionally, if user 102 is with a date or with family, user 102 may wish to attend a restaurant prior to the event, eat at the venue, or have food delivered by a merchant at the venue. Thus, information pertaining to the aforementioned parameters may also be collected by user information application 112.

Moreover, user information application 112 may collect information about the venue and/or event as well as current parameters at the event. User information application may collect information about crowd levels at the venue, weather and/or temperature parameters at the venue, temperature parameters corresponding directly to user 102, sound and visibility levels for user 102, and/or physical parameters of user 102. Thus, core temperature, perspiration, sound levels, visibility, and/or weather parameters may be collected and indicative of a comfort level of user 102.

Once information corresponding to at least one parameter of user 102 is collected by user information application 112, ticket application 120 may transmit the information to event ticketing server 130 for processing and use, as will be discussed in more detail herein. Ticket application 120 may be utilized to, for example, provide a convenient interface to permit a user to browse information available over network 160 and utilize services available on service providers. In certain embodiments, ticket application 120 may be implemented as a web browser configured to view information available over the Internet or access a website of a service provider, including event ticketing server 130, venue server 140, and/or payment provider server 150. For example, ticket application 120 may be utilized to access websites and engage in online transactions with a service application of event ticketing server 130 and/or venue server 140. Additionally, ticket application 120 may access other service provider websites, such as payment provider server 150, to facilitate online payments, financial websites to view financial information and engage in financial transactions, messaging websites, social networking websites, and/or other online source.

Ticket application 120 may be configured to provide an interface to display purchase options available at or near a venue user 102 is attending. Thus, ticket application 120 may receive purchase options from event ticketing server 130 and/or venue server 140 for display to user 102. User 102 may utilize ticket application 120 to further select at least one of the purchase options and transmit the acceptance of the purchase option to event ticketing server 130 and/or venue server 140. If the option corresponds to a change in seating for user 102 at the venue, ticket application 120 may display the change of seating, a bar/QR code enabling a scan of and verification of the new admission information, an authorization code number, and/or other information enabling an authority at the venue to admit user 102. Where the purchase option corresponds to items (e.g., good, food, service, etc.) at the venue, ticket application 120 may display information corresponding to where user 102 may retrieve the items or visit the merchant, or may transmit information corresponding to a position of user 102 for delivery by the merchant.

Once a purchase order is transmitted to user 102, user 102 may accept the purchase order. Thus, ticket application 120 may include payment processes. For example, ticket application 120 may provide a convenient interface to permit user 102 to select payment options and provide payment for items and/or services including purchase orders. Ticket application 120 may be implemented as an application having a user interface enabling the user to enter payment options for storage by user device 110, provide payment options on checkout/payment of a purchase order, and complete a transaction for the purchase order. In some embodiments, ticket application 120 may correspond more generally to a web browser configured to view information available over the Internet or access a website corresponding to a payment application. Ticket application 120 may utilize user financial information, such as a credit card, bank account, or other financial account. Additionally, ticket application 120 may provide payment for items using a user account with payment provider, such as payment provider server 150.

In various embodiments, user information application 112 and ticket application 120 may be incorporated in the same application so as to provide their respective features in one convenient application interface.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with payment provider server 150. Other applications 114 may contain software programs, executable by a processor, including a graphical user interface (GUI) configured to provide an interface to the user.

User device 110 may further include database 116 which may include, for example, identifiers such as operating system registry entries, cookies associated with user information application 112, ticket application 120, and/or other applications 114, identifiers associated with hardware of user device 110, or other appropriate identifiers, such as identifiers used for payment/user/device authentication or identification. In certain embodiments, identifiers in database 116 may be used by an account provider, such as event ticketing server 130, venue server 140, and/or payment provider server 150, to associate user device 110 with a particular account maintained by the account provider. Database 116 may include admission information corresponding to admission for an event at a venue. Furthermore, database 116 may further include information corresponding to parameters of user 102.

In various embodiments, user device 110 includes at least one network interface component 118 adapted to communicate with event ticketing server 130, venue server 140, and/or payment provider server 150 over network 160. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Event ticketing server 130 may be maintained, for example, by an online seller entity, which may provide ticket sales, upgrades, and additional event purchases for user 102 on behalf of a venue corresponding to venue server 140. In this regard, event ticketing server 130 may include one or more ticket servicing applications configured to receive admission information for user 102 to an event and collect information corresponding to parameters of user 102. In one example, event ticketing server 130 may be provided by STUBHUB®, Inc. of San Francisco, Calif., USA. While event ticketing server 130 is shown as separate from venue server 140 and payment provider server 150, it is understood the services provided by event ticketing server 130 may be incorporated within one or more of venue server 140 and/or payment provider server 150.

Event ticketing server 130 includes a ticket servicing application 132, other applications 134, a database 136, and a network interface component 138. Ticket servicing application 132 and other applications 134 may correspond to processes, procedures, and/or applications executable by a hardware processor, for example, a software program. In other embodiments, event ticketing server 130 may include additional or different software as required

Event ticketing server 130 includes ticket servicing application 132, which may be configured to determine one or more purchase options for user 102 and assist user 102 in accepting and completing a transaction for those purchase options. In this regard, ticket servicing application 132 may receive and/or access admission information corresponding to a ticket that user 102 has for an event at a venue. Ticket servicing application 132 may first assist user 102 in purchasing the original admission information. However, in other embodiments, user 102 and/or another server, such as venue server 140, may transmit the admission information to event ticketing server 130 after a purchase from another source.

Ticket servicing application 132 may further access at least one parameter corresponding to user 102. As previously discussed, information about parameters of user 102 may be collected by user information application 112 of user device 110. Additionally, information corresponding to parameters of user 102 and/or parameters of user 102 may be received from venue server 140 and/or payment provider server 150, as will be explained in more detail herein. For example, venue server 140 may transmit information about weather, temperature, and/or crowd information at the venue. Payment provider server 150 may provide information about available funds in a payment account and/or received funds (e.g., paychecks from an employer).

In various embodiments, ticket servicing application 132 may process the information to determine the parameter(s) of user 102. For example, ticket servicing application 132 may receive information about sleep patterns of user 102, daily meetings of user 102, and/or exercise schedules of user 102. Thus, ticket servicing application 132 may utilize this information to determine a rest/alert level of user 102. For example, high levels of exercise, lack of sleep, multiple daily excursions, increases in travel time/distance, and/or large increases in daily workloads may correspond to a tired parameter of user 102. Conversely, the opposite information may correspond to an alert level of user 102.

Additionally, weather and/or temperature information may be utilized with heart rate, core temperature, and/or perspiration, to determine a parameter of user 102. Thus, parameters of user 102 may be determined using a user history of the user comprising at least one of user purchases, user physical activity, user work activity, and a user financial account. Additionally, the parameter(s) may be determined based on a current state of user 102, weather parameters for the venue, and/or temperature levels at a location of the user within the venue. This information may correspond to a current comfort and/or physical parameter of user 102. Information corresponding to these parameters may be determined from information available prior to and while user 102 is at the venue.

Parameters may also be determined based on the company of user 102. For example, if user 102 is associated with trusted nearby devices, user 102 may be with a known associate. Thus, based on the information about the trusted device and/or information about user 102, it may be determined user 102 is on a date, is out with family, or is attending the venue with friends. Information for the parameters may be received from user device 110, venue server 140, and/or payment provider server 150. In certain embodiments, information corresponding to the parameters may be crowd sourced from at least one other user attending the venue or scraped from social networking and/or microblogging sources corresponding to user 102 or other users at the venue.

Once at least one parameter corresponding to user 102 is determined, ticket servicing application 132 may access the at least one parameter. Ticket servicing application 132 may then determine a purchase option corresponding to the parameter. Purchase options may correspond to a change in seating or admission for the admission information of user 102. For example, if the parameter corresponds to a tired parameter of user 102, ticket servicing application 132 may determine user 102 may prefer seated admission and/or VIP admission to the venue instead of standing general admission. In other embodiments, financial information about user 102 may cause ticket servicing application 132 to offer upgrades to better seats when user 102 can afford the upgrades. Weather, purchases, and/or physical parameters corresponding to user 102 may determine user 102 would prefer air conditioned box seats/shade covered seats if user 102 is warm or expected to be warm. Conversely, if user 102 is cold or expected to be in a cold venue, user 102 may be offered seats in directly sunlight or in a heated VIP section/box seats. Thus, if user 102 is purchasing a specific type of item, or body parameters of user 102 indicate a certain parameter, purchase options may correspond to changes in the admission information in accordance with the parameter.

In other embodiments, the purchase option may correspond to items available with merchants at or near the venue. Thus, if user 102 is determined to be tired, user 102 may be offered coffee or energy drinks at the venue or from merchants near the venue. Where user 102 is hot or cold, beverages, such as water, beer, or sodas when hot and hot cocoa, coffee, or tea when cold, may be offered through purchase options to user 102. If user 102 is attending an event prior to eating, restaurant and/or concession food options at or near the venue may be offered to user 102. Additionally, if user 102 is attending the venue with a friend, family, or a date, restaurant and/or food options appropriate for each scenario may be offered to user 102.

Ticket servicing application 132 may also process purchase orders. Purchase order may be processed using one or more of user device 110, venue server 140, and/or payment provider server 150. Where the purchase order is for changes to seating or admission, an electronic ticket reflecting the changes or a transaction history may be provided to user 102 to provide proof of purchase and admission. The transaction history may include transaction numbers, a bar/QR code, or other information for user 102 to use for admission. In other embodiments where the purchase order corresponds to items available at the venue, a map to the merchant may be provided to user 102. If the merchant corresponds to a restaurant or food service, user 102 may purchase prior to or when arriving at the restaurant/food service. Discounts may be offered to purchasing prior to arrival at the merchant and/or bulk purchases. Moreover, a location service/device of user device 110, such as a GPS locator, may transmit a location of user 102 to the merchant so that the merchant may deliver items directly to user 102.

In various embodiments, event ticketing server 130 includes other applications 134 as may be desired in particular embodiments to provide features for event ticketing server 130. For example, other applications 134 may include security applications for implementing server-side security features, programmatic server applications for interfacing with appropriate application programming interfaces (APIs) over network 160, or other types of applications. Other applications 134 may contain software programs, such as a graphical user interface (GUI), executable by a processor that is configured to provide an interface to the user.

Event ticketing server 130 includes database 136, which may be configured to store user account identifiers, account community information, and/or promotion material. Database 136 may further include transaction information, seller information, admission information, and/or parameters and parameter information for user 102, as previously discussed. Database 136 may include information about user purchase orders, including completed purchase orders for use for admission to the venue by user 102 and/or merchants at or near the venue.

In various embodiments, event ticketing server 130 includes at least one network interface component 138 adapted to communicate with network 160 including user device 110, venue server 140, payment provider server 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Venue server 140 may be maintained, for example, by a service provider offering a venue for events that user 102 may attend. Venue server 140 may correspond generally to a venue owner offering events that may be attended through admission of users. Venue server 140 may correspond to one or a plurality of venues. Additionally, venue server 140 may offer items, products, and/or services corresponding to the venue and be maintained by anyone or any entity that receives money, which includes charities as well as retailers and restaurants. In this regard, venue server 140 may include processing applications, which may be configured to interact with user device 110, event ticketing server 130, and/or payment provider server 150 over network 160 to facilitate the sale of event admission, products, goods, and/or services. Although venue server 140 is shown as separate from event ticketing server 130 and payment provider server 150, it is understood the services provided by venue server 140 may be incorporated within one or more of event ticketing server 130 and/or payment provider server 150.

Venue server 140 includes a venue application 142, a database 144, and a network interface component 146. Venue application 142 may correspond to processes, procedures, and/or applications executable by a hardware processor, for example, a software program. In other embodiments, venue server 140 may include additional or different software as required.

In certain embodiments, venue application 142 may correspond to a ticket and/or item sales application on a server enabling a user to view and/or purchase various admission tickets to a venue and items available at or near the venue. Thus, venue application 142 may include an application interface and/or API enabling at least one of user device 110 and event ticketing server 130 to access venue server 140 and purchase from venue server 140. Venue application 142 may facilitate the exchange of money for admission/items using user device 110 and/or payment provider server 150. More generally, venue application 142 may provide services to user 102 over network 160, including information services for the venue. Venue application 142 may sell upgrades to admission for user 102, such as changes to seating and/or admission (e.g., seats, sections, etc.) or may allow users to exchange admission for other admission (e.g., exchange seats, section, etc.). Venue application 142 may further include information for available merchants at or near the venue including menus of merchant items, goods, products, and/or services. Venue application 142 may facilitate the sale of items from the merchant, including payment to the merchant from user 102. Additionally, venue application 142 may provide information for user 102 to find the merchant, make reservations or holds with the merchant, etc. Venue application 142 may alert the merchant of user 102's location in order to provide delivery of purchased items to user 102. Transaction information corresponding to purchased admission and/or items for a venue, such as by user 102, may be transmitted to user device 110 and/or event ticketing server 130 for association with user 102.

Venue server 140 includes database 144, which may include user information including purchased admission information, purchased items, user identifiers, and/or user location information corresponding to user 102. Database 142 may further include available admission tickets at a venue corresponding to venue server 140, admission ticket prices, and other information relevant to purchase of admission to the venue. Database 144 may include collections of merchant information, such as available merchants, merchant menus, and/or merchant locations. Information in database 144 may be utilized by one or more of user device 110, event ticketing server 130, and/or payment provider server 150 to present and complete purchase orders corresponding to parameters of user 102.

In various embodiments, venue server 140 includes at least one network interface component 146 adapted to communicate with network 160 including user device 110, event ticketing server 130, and/or payment provider server 150. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 150 may be maintained, for example, by an online payment service provider, which may provide payment services and/or processing for financial transactions on behalf of user 102. In this regard, payment provider server 150 includes one or more processing applications which may be configured to interact with user device 110, event ticketing server 130, and/or venue server 140 to facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102. Although payment provider server 150 is shown as separate from event ticketing server 130 and venue server 140, it is understood the services provided by payment provider server 150 may be incorporated within one or more of event ticketing server 130 and/or venue server 140.

Payment provider server 150 of FIG. 1 includes a transaction processing application 152, other application 154, user accounts 156, and a network interface component 158. Transaction processing application 152 may correspond to processes, procedures, and/or applications executable by a hardware processor, for example, a software program. In other embodiments, payment provider server 150 may include additional or different software as required.

Transaction processing application 152 may be configured to receive and/or transmit information from user device 110, event ticketing server 130, and/or venue server 140 for processing and completion of financial transactions. Transaction processing application 152 may include one or more applications to process financial transaction information from user device 110, event ticketing server 130, and/or venue server 140 by receiving a request to complete a sale transaction for items/services/goods including admission tickets to a venue corresponding to venue server 140. The request may correspond to a payment from user device 110 to event ticketing server 130 and/or venue server 140. The payment may include a user account identifier (e.g., a payment account for user 102 with payment provider server 150) or other payment information (e.g. a credit/debit card or checking account). Additionally, the payment may include a payment amount and terms of payment. Transaction processing application 152 may complete the transaction by providing payment to event ticketing server 130 and/or venue server 140. Additionally, transaction processing application 152 may provide transaction histories, including receipts, to user device 110, event ticketing server 130, and/or venue server 140 for completion and documentation of the financial transaction.

Payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 160, or other types of applications. Other applications 154 may contain software programs, such as a graphical user interface (GUI), executable by a processor that is configured to provide an interface to a user. Other applications 154 may include account applications, including user account services, financial accounting services, and/or financial statement services. Thus, information provided by the account application(s) may be utilized by event ticketing server 130 to determine a financial parameter of user 102 (e.g., current bank account balances, date of paycheck payment, etc.).

Additionally, payment provider server 150 includes database 156. As previously discussed, user 102 may establish one or more user accounts with payment provider server 150. User accounts in database 156 may include user information, such as name, address, birthdate, payment/funding information, additional user financial information, and/or other desired user data. User 102 may link user accounts in database 156 to user device 110 through a user device identifier. Thus, when a device identifier corresponding to user device 110 is transmitted to payment provider server 150 (e.g., from user device 110, event ticketing server 130, and/or venue server 140), a user account belonging to user 102 may be found. More generally, user accounts in database 156 may correspond to an account established by a user and maintained for engaging in online transactions. Payment provider server 150 may actively request information for database 156, allow a user to submit information, or may retrieve information corresponding to user 102 and/or user device 110, such as by monitoring IP addresses used to access the user account, locations of access, machine cookies, or other user and/or device specific data. However, in other embodiments, user 102 may not have previously established a user account. Thus, payment provider server 150 may complete a transaction based on another user financial account received from user device 110, event ticketing server 130, and/or venue server 140. Information in database 156 may be provided to one or more of user device 110, event ticketing server 130, and/or venue server 140 in order to determine a parameter of user 102, including a financial parameter or a state of a financial account belonging to user 102.

In various embodiments, payment provider server 150 includes at least one network interface component 158 adapted to communicate with user device 110, event ticketing server 130, and/or venue server 140 over network 160. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

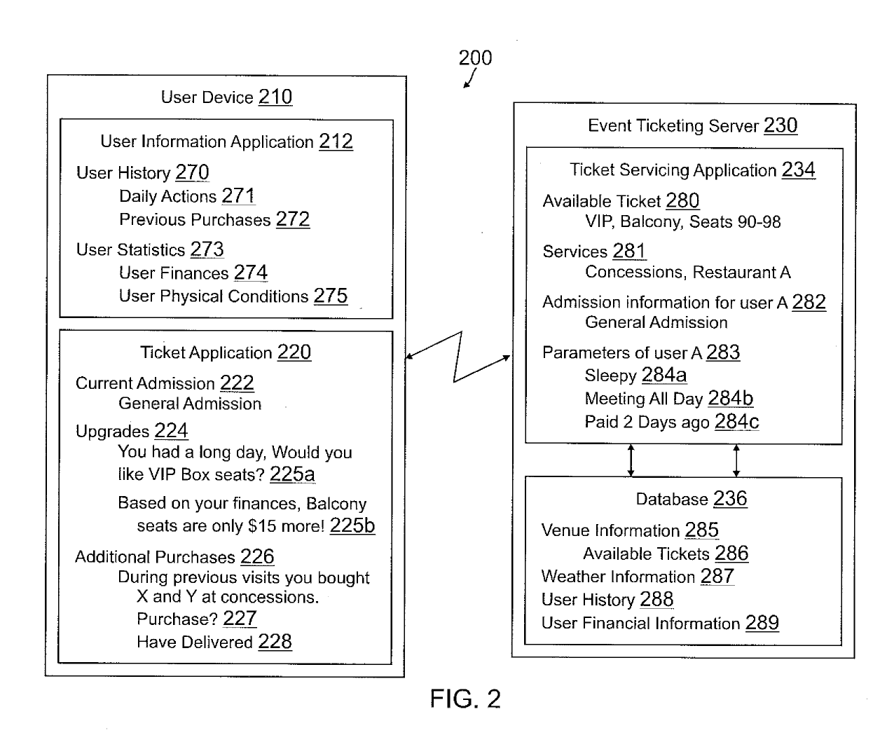

FIG. 2 is an exemplary interaction between a ticketing server and a user device for providing purchase and upgrade options for a venue, according to an embodiment. FIG. 2 includes a user device 210 and an event ticketing server 230 corresponding generally to user device 110 and event ticketing server 130, respectively, of FIG. 1.

As shown in FIG. 2, user device 210 includes a user information application 212 and a ticket application 220 corresponding generally to the described functions and processes of user information application 112 and ticket application 120, respectively, of FIG. 1. As previously discussed, user information application 212 may include and/or collect information from one or more sensors, devices, applications, and/or connections of user device 210 that corresponds to parameters of a user (e.g., user 102). Thus, user information application 212 includes user history 270 and user statistics 273. User history 270 may include user purchases, user physical activity, user work activity, and/or other previous activity. For example, user history 270 includes daily actions 271, which may include user physical activity and/or user work activity, such as physical exercise, distance traveled, mode of transportation, daily meetings and/or work productivity, vacation time, etc. Information in daily actions 271 may also be relevant to an “alert” or “tired” parameter of the user. User history 270 includes previous purchases 272. Previous purchases 272 may include user purchases (e.g., food, beverage, etc.) throughout a day. Such information may be relevant to a “hungry” or “thirsty” parameter of the user, or may be indicative of the user desiring coffee or an energy drink. Previous purchases 272 may also include information about previous purchases of the user when attending a venue, including the venue for an upcoming event or other venues the user has previously attended. Previous purchases 272 may be utilized to determine a parameter of the user at the event (e.g., prefers hot/cold drinks, eats at venues, etc.) and may be utilized to determine preferred parameters (e.g., purchases 2 bottles of water, 2 beers, etc.) at each event so that the preferred parameters may be offered to the user.

User information application 212 further include user statistics 273, which may correspond to present user statistics collected from one or more sources. Present user statistics 273 may include user finances 274 and user physical conditions 275. User finances 274 may correspond to a present financial account of the user as well as incoming debits and payments (e.g., from paychecks, etc.) and also debits. User finances 274 may determine a financial parameter of the user, such as if the user can afford upgrades in tickets, certain items at the venue, etc. User physical conditions 275 may be collected from user device 210, a device attached to user device 210, and/or information about the venue (including from the venue and/or crowd sourced from users at the venue). For example, user device 210 may take an ambient temperature, light level, and/or sound level reading corresponding to a physical parameter of the user. Additionally, perspiration and/or humidity may be determined for the user. Thus, a “hot,” “sweaty,” or “dry” parameter may be determined corresponding to the user in order to determine a state of the user.

Information from user information application 212 may be transmitted to event ticketing server 234 for using in determining parameters of the user. Event ticketing server 230 includes a ticket servicing application 234 and a database 236 corresponding generally to the described functions and processes of ticket servicing application 234 and database 236 of FIG. 1. In addition to information from user device 210, event ticketing server 230 may receive information from other sources (e.g., a venue, a financial account, etc., of the user) and store the information to database 236. Thus, information from user information application 212 and database 236 may be used by event ticketing application 234 to determine at least one parameter for the user attending the venue. Information stored to database 236 may include venue information 285, which may correspond generally to any information available for a venue, including crowd information, weather and/or temperature information, humidity information, etc. Additionally, venue information 285 includes available tickets 286, which may be utilized to determine purchase options for the user based on available upgrades and/or admission ticket exchanges. Database 236 include weather information 287, which may correspond to the venue and/or surrounding areas at the venue, including for potential travel, tailgating, or similar purchase options. Database 236 may include user history 288 and user financial information 289, which may correspond to similar information previously discussed in references to user history 270 and user finances 274, respectively, of user device 210, or include further information received from additional sources.

Thus, ticket servicing application 234 may determine purchase options using the aforementioned information. Ticket servicing application 234 may first access admission information for user A 282 and parameters of user A 283. As shown in FIG. 2, admission information for user A 282 corresponds to “General Admission.” Additionally, parameters for user A 283 include 284a, 284b, and 284c. Parameter 284a may be determined based on a user sleep schedule, exercise, daily travel, etc., as previously discussed, and correspond to a “sleepy” or “tired” state. Additionally, 284a may be determined based on additional parameters for user A 283, such as 248b corresponding to “meetings all day.” Parameters for user A 283 further include ago 284c, which may correspond to a financial parameter of user A determined from financial information received about user A, described as “paid 2 days ago.”

Purchase options may correspond to available tickets 280 and services 281. Available tickets 280 in FIG. 2 are shown as VIP, balcony, and seats 90-98. Thus, available tickets 280 may be received from and/or determined for a venue and utilized to determine a preferable purchase option for the user. Services 281 in FIG. 2 include concessions and restaurant A, which also may be received from and/or determined for the venue. Services 281 may further be used to offer preferred service purchase options to the user.

The user utilizing user device 210 may then access ticket application 220 to view current purchases and purchase options. Thus, ticket application 220 may display to the user current admission 222, upgrades 224, and additional purchases 226. Current admission 222 may display the present admission information for the user and may be utilized by one or more authorities at the venue to admit the user to the venue. Upgrades 224 may display potential purchase options for the admission information based on the parameters of the user. Thus, upgrades 224 include 225a, which includes an upgrade to VIP seats based on a physical “sleepy/tired” parameter of the user, and 225b, which includes an upgrade based on the financial status of the user. Upgrades 224 are directed to the user based on a physical parameter of the user and a financial parameter of the user. Other parameters may also be used and may be mixed to determine other purchase options for the user. The user is also offered additional purchases 226, which includes 227 and 288 corresponding to previous purchases of X and Y while the user is at concessions at the venue. 227 may enable the user to purchase the items, potentially at a discount, prior to arriving at concessions and pay using user device 210. Additionally, the user may utilize 228 to have X and Y delivered to the user, as previously discussed.

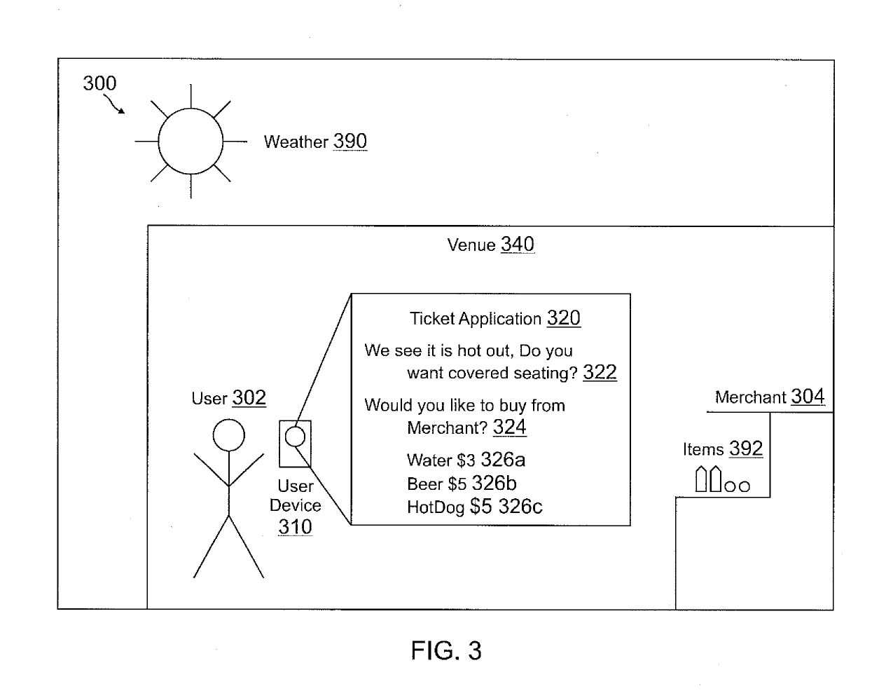

FIG. 3 is an exemplary system environment displaying a user at an event and receiving purchase and upgrade options based on the parameters of the user, according to an embodiment. FIG. 3 includes an environment 300 including a venue 340 having a user 302 holding a user device 310 corresponding generally to user 102 and user device 110, respectively, of FIG. 1.

Environment 300 includes venue 340 and weather 390. Venue 340 may correspond generally to a location hosting an event, such a sports arena for a sporting event, a theater for a show or concert, or a similar location. Additionally, venue 340 may offer tickets for sale, such as through a ticketing vendor (e.g., event ticketing server 130 of FIG. 1) and/or a server for the venue (e.g., venue server 140 of FIG. 1). Venue 340 hosts user 302 and includes merchant 304. User 302 may attend venue 340 with user device 310. Additionally, information may be collected about user 302 and/or about conditions at venue 340 that may affect user 302, such as weather 390. Thus, purchase options available at venue 340 may be offered to user 302, such as changes to admission/seating and/or items 392.

Thus, while at venue 340, user 302 may experience weather 390 that may correspond to sunny and hot weather. Thus, parameters for user 302 may correspond to “hot” or “sweaty.” Such parameters may be collected from information about weather 390 and/or information about user 302. For example, weather conditions may determine the parameter “hot,” while user pulse/heart rate, perspiration, local temperature, and/or humidity may correspond to a “hot” or “sweaty” parameter of user 302. Based on these parameters, user 302 may be offered items 392 from merchant 304.

Thus, user 302 may view purchase options through user device 310. User device 310 may display ticket application 320 to user 302. Ticket application 320 includes options 322 and 324 corresponding to available purchase options. Option 322 includes a purchase option for a change in admission and/or seating for user 302's admission information. Thus, option 322 includes a purchase option that correspond to detecting a “warm,” “hot,” or “sweaty” parameter of user 302, enabling user 302 to purchase covered seating.

Additionally, user 302 may see a purchase option for merchant 302 based on the parameter(s) of user 302. Thus, option 324 includes purchase options for items 392 available with merchant 304. Option 324 includes purchase options for a menu from merchant 304 including water 326a, beer, 326b, and a hot dog 324c. While a menu is displayed in FIG. 3, 324 may include in other embodiments only items that may correspond to the parameter of user 302, or additional menu information.

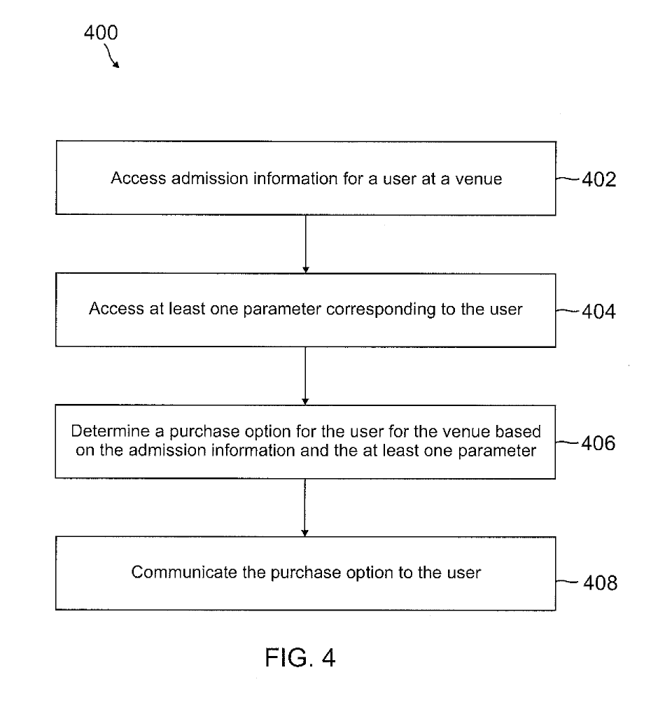

FIG. 4 is a flowchart of an exemplary process by a server for purchase and upgrade options based on user parameters, according to an embodiment. Note that one or more steps, processes, and methods described herein may be omitted, performed in a different sequence, or combined as desired or appropriate.

At step 402, admission information for a user at a venue is accessed. Admission information may correspond to tickets to an event at a venue. The admission information may be received from the user, from a venue/venue server that provided the tickets, and/or a ticket vendor that may provide the tickets to the user.

At least one parameter corresponding to a user is accessed, at step 404. The at least one parameter may comprise at least one of a physical parameter of the user, financial information of the user, and/or a preference of the user. The at least one parameter may be determined by a server, including a ticket vendor that may offer the admission ticket. The at least one parameter may be determined using a user history of the user comprising at least one of user purchases, user physical activity, user work activity, and a user financial account. Moreover, in various embodiments, the at least one parameter may be determined using weather parameters for the venue and temperature levels at a location of the user within the venue. Additionally, information may be received corresponding to the at least one parameter, such as from the venue, a user device of the user, and another user attending the venue (i.e., crowd sourced and/or scraped from feeds corresponding to the user(s)). The information may be utilized to determine the at least one parameter. The parameter may correspond to a parameter of the user prior to or while attending the venue.

Thus, at step 406, a purchase option for the user for the venue is determined based on the admission information and the at least one parameter. At step 408, the purchase option is communicated to the user so that the user may accept the purchase option. The purchase option may comprise a change in seating or admission for the admission information. Thus, a server may receive acceptance of the purchase option and process the admission information to account for the change. In other embodiments, the purchase option may be for an item available at the venue. Thus, acceptance of the purchase option may be transmitted to a merchant holding the item at the venue. In various embodiments, the merchant may deliver the item to the user by receiving user location information at the venue.

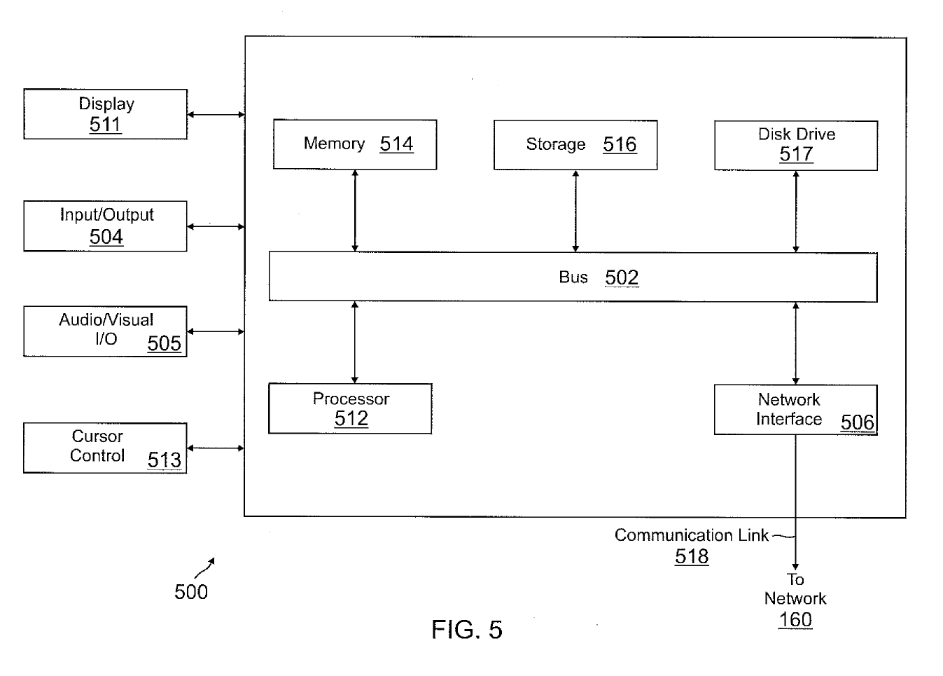

FIG. 5 is a block diagram of a computer system 500 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user information comprising admission information for a user at a venue; and
one or more hardware processors in communication with the non-transitory memory and configured to:
access the admission information for the user at the venue;
access at least one parameter corresponding to the user;
determine a purchase option for the user for the venue based on the admission information and the at least one parameter; and
communicate the purchase option to the user.

2. The system of claim 1, where the at least one parameter comprises at least one of a physical parameter of the user, financial information of the user, and a preference of the user.

3. The system of claim 1, wherein the one or more hardware processors is further configured to:
determine the at least one parameter of the user.

4. The system of claim 3, wherein the at least one parameter is determined using a user history of the user comprising at least one of user purchases, user physical activity, user work activity, and a user financial account.

5. The system of claim 3, wherein the at least one parameter is determined using weather parameters for the venue and temperature levels at a location of the user within the venue.

6. The system of claim 3, wherein the one or more hardware processors is further configured to:
receive information corresponding to the at least one parameter from at least one of the venue, a user device of the user, and another user attending the venue,
wherein the at least one parameter is determined using the information.

7. The system of claim 1, wherein the at least one parameter comprises a present parameter of the user while at the venue.

8. The system of claim 1, wherein the purchase option comprises a change in seating or admission for the admission information.

9. The system of claim 8, wherein the one or more hardware processors is further configured to:
receive an acceptance of the purchase option; and
process the admission information with the acceptance to include the change of seating.

10. The system of claim 1, wherein the purchase option is for an item available at the venue.

11. The system of claim 10, wherein the one or more hardware processors is further configured to:
process an acceptance of the purchase option; and
transmit the acceptance to a merchant holding the item at the venue.

12. The system of claim 11, wherein the merchant delivers the item to the user.

13. A method comprising:
accessing admission information for a user at a venue;
accessing at least one parameter corresponding to the user;
determining, using one or more hardware processors, a purchase option for the user for the venue based on the admission information and the at least one parameter; and
communicating the purchase option to the user.

14. The method of claim 13, where the at least one parameter comprises at least one of a physical parameter of the user, financial information of the user, and a preference of the user.

15. The method of claim 13 further comprising:
determining the at least one parameter of the user using a user history of the user comprising at least one of user purchases, user physical activity, user work activity, and a user financial account.

15. The method of claim 13 further comprising:
determining the at least one parameter of the user weather parameters for the venue and temperature levels at a location of the user within the venue.

16. The method of claim 13 further comprising:
receiving information corresponding to the at least one parameter from at least one of the venue, a user device of the user, and another user attending the venue,
wherein the at least one parameter is determined using the information.

17. The method of claim 13, wherein the purchase option comprises a change in seating or admission for the admission information.

18. The method of claim 17 further comprising:
receiving an acceptance of the purchase option; and
processing the admission information with the acceptance to include the change of seating.

19. The method of claim 12, wherein the purchase option is for an item available at the venue, and wherein a merchant at the venue delivers the item to the user.

20. A non-transitory computer readable medium comprising a plurality of machine-readable instructions which when executed by one or more processors of a server are adapted to cause the server to perform a method comprising:
accessing admission information for a user at a venue;
accessing at least one parameter corresponding to the user;
determining a purchase option for the user for the venue based on the admission information and the at least one parameter; and
communicating the purchase option to the user.
